(19) United States
(12) Patent Application Publication
(10) Pub. No.: US 2010/0243582 A1
(43) Pub. Date: Sep. 30, 2010

(54) Droplet Forming Fluid Treatment Devices and Methods of Forming Filtered Droplets in a Fluid Treatment Device

(75) Inventors: Richard Paul Riedel, Mason, OH (US); Douglas Robert Utsch, Blanchester, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: PUR WATER PURIFICATION PRODUCTS, INC., Cincinnati, OH (US)

(21) Appl. No.: 12/732,277

(22) Filed: Mar. 26, 2010

Related U.S. Application Data
(60) Provisional application No. 61/164,158, filed on Mar. 27, 2009.

(51) Int. Cl. B01D 35/28

(52) U.S. Cl. 210/767; 210/435

(57) ABSTRACT

A fluid treatment device includes a housing having an upper portion including an upper reservoir for receiving unfiltered fluid, a lower portion including a lower reservoir for receiving filtered fluid and an intermediate portion including a droplet forming fluid filtering system. The droplet forming filtering system comprises a rain-effect delivery system that receives fluid from the upper reservoir, the rain-effect delivery system having a fluid delivery surface configured for forming individual fluid droplets over an area of the fluid delivery surface.

### CROSS-REFERENCE TO RELATED APPLICATIONS

This application claims priority to U.S. Provisional Application Ser. No. 61/164,158, filed Mar. 27, 2009, the details of which are incorporated herein by reference.

### TECHNICAL FIELD

The present invention is generally directed to fluid treatment devices and, more particularly, to fluid treatment devices and methods of their use that form filtered fluid droplets (e.g., of potable water).

### BACKGROUND

Consumer interest in drinking water continues to rise. Sales of bottled water and water treatment devices, such as pitchers/carafes used to filter water are significant. For example, bottled water sales in the United States surpassed 8 billion gallons in 2006. Thus, suppliers of drinking water and water treatment devices work diligently to try to set their products apart from others in the industry.

Domestic water treatment devices include in-line devices (e.g., under the sink), terminal end devices (e.g., counter top or faucet mounted), and self-contained systems which process water in batches. Examples of batch devices are pitchers/carafes and larger reservoirs where treated water is poured, for example, from a spigot. Batch water treatment systems can also be incorporated into other devices, such as a coffee maker. These self-contained systems typically have upper and lower chambers separated by a filter cartridge and rely on gravity to force water from the upper chamber, through the cartridge, and into the lower chamber, thereby producing treated water.

### SUMMARY

In an aspect, a fluid treatment device includes a housing having an upper portion including an upper reservoir for receiving unfiltered fluid, a lower portion including a lower reservoir for receiving filtered fluid and an intermediate portion including a droplet forming fluid filtering system. The droplet forming filtering system comprises a rain-effect delivery system that receives fluid from the upper reservoir, the rain-effect delivery system having a fluid delivery surface configured for forming individual fluid droplets over an area of the fluid delivery surface.

In another aspect, a fluid treatment device includes a housing having an upper portion including an upper reservoir for receiving unfiltered fluid, a lower portion including a lower reservoir for receiving filtered fluid and an intermediate portion. A droplet forming fluid filtering system is at the intermediate portion. The droplet forming filtering system includes a filter media configured to filter the unfiltered fluid from the upper portion of the housing. A rain-effect delivery system receives filtered fluid from the filter media. The rain-effect delivery system has a fluid delivery surface configured for forming individual filtered fluid droplets over an area of the fluid delivery surface.

In another aspect, a method of providing filtered fluid using a fluid treatment device is provided. The method includes filling an upper reservoir of the fluid treatment device with unfiltered fluid. The unfiltered fluid is filtered thereby providing filtered fluid using a filter media. Individual filtered fluid droplets are formed using a rain-effect delivery system that receives filtered fluid from the filter media. The rain-effect delivery system has a fluid delivery surface configured for forming individual filtered fluid droplets over an area of the fluid delivery surface.

In another aspect, a method of providing a device suitable for filtering a fluid is provided. The method includes providing a filter cartridge with a fluid delivery surface and selecting a material for the fluid delivery surface having a surface energy suitable for forming individual filtered fluid droplets over an area of the fluid delivery surface during a filtering operation.

### BRIEF DESCRIPTION OF THE DRAWINGS

The following detailed description of specific embodiments of the present invention can be best understood when read in conjunction with the drawings enclosed herewith.

FIG. 1 is a perspective view of an embodiment of a fluid treatment device;

FIG. 2 is a section view of another embodiment of a fluid treatment device;

FIG. 3 is a detail view at area 3 of the fluid treatment device of FIG. 2;

FIG. 4 is a perspective view of an embodiment of a droplet forming fluid filtering system for use in the fluid treatment device of FIG. 2;

FIG. 5 is a perspective view of an embodiment of a rain-effect delivery system for use in the droplet forming filtering system of FIG. 4;

FIG. 6 is a bottom view of the rain-effect delivery system of FIG. 5;

FIG. 7 is a detail view at area 7 of the rain-effect delivery system of FIG. 6;

FIG. 8 diagrammatically illustrates formation of a droplet using the droplet forming fluid filtering system of FIG. 4;

FIG. 9 is a diagrammatic section view of the droplet forming fluid filtering system of FIG. 4;

FIG. 10 diagrammatically illustrates operation of the droplet forming fluid filtering system of FIG. 4;

FIG. 11 is a side view of another embodiment of a fluid treatment device;

FIG. 12 is a detailed, perspective view of an embodiment of a rain-effect delivery system;

FIG. 13 illustrates another embodiment of a rain-effect delivery system;

FIG. 14 is a diagrammatic illustration of the rain-effect delivery system of FIG. 13 in use;

FIG. 15 illustrates another embodiment of a rain-effect delivery system;

FIG. 16 is a diagrammatic illustration of the rain-effect delivery system of FIG. 15 in use;

FIG. 17 illustrates another embodiment of a rain-effect delivery system;

FIG. 18 is a diagrammatic illustration of the rain-effect delivery system of FIG. 17 in use; and

FIG. 19 illustrates another embodiment of a rain-effect delivery system;

FIG. 20 is a diagrammatic illustration of the rain-effect delivery system of FIG. 19 in use;

FIG. 21 illustrates another embodiment of a fluid treatment device utilizing the rain-effect delivery system of FIG. 19.

The embodiments set forth in the drawings are illustrative in nature and not intended to be limiting of the invention defined by the claims. Moreover, individual features of the drawings and invention will be more fully apparent and understood in view of the detailed description.

### DETAILED DESCRIPTION

As used herein, a “droplet” or “drop” is a small volume of liquid, bounded completely or almost completely by free surfaces.

As used herein, “rain-effect” refers to multiple droplets falling from drop points (e.g., at least six drop points) under the force of gravity through a given volume over time where the path of the multiple droplets intersect a horizontal plane at different locations spread-apart over a surface of the horizontal plane.

A “transparent” material or object refers to a material or object formed of such a material that transmits light through its substance so that bodies situated beyond or behind can be readily seen.

A “translucent” material or object refers to a material or object formed of such a material that transmits light but causes sufficient diffusion to prevent perception of distinct images through the translucent material.

An “opaque” material or object refers to a material or object formed of such a material that does not allow light to pass therethrough.

As used herein, “surface tension” is a phenomenon that results directly from intermolecular forces between molecules of liquids. In other words, molecules at the surface of a drop of liquid experience a net force drawing them to the interior, which creates a tension in the liquid surface. The surface tension of a liquid is measured in dynes/cm.

As used herein, “surface energy” quantifies the partial disruption of intermolecular bonds that occurs when a surface is created. For practical purposes, the surface energy of a solid substance is expressed in relation to dynes/cm and is sometimes referred to as surface tension of the surface of the solid substance.

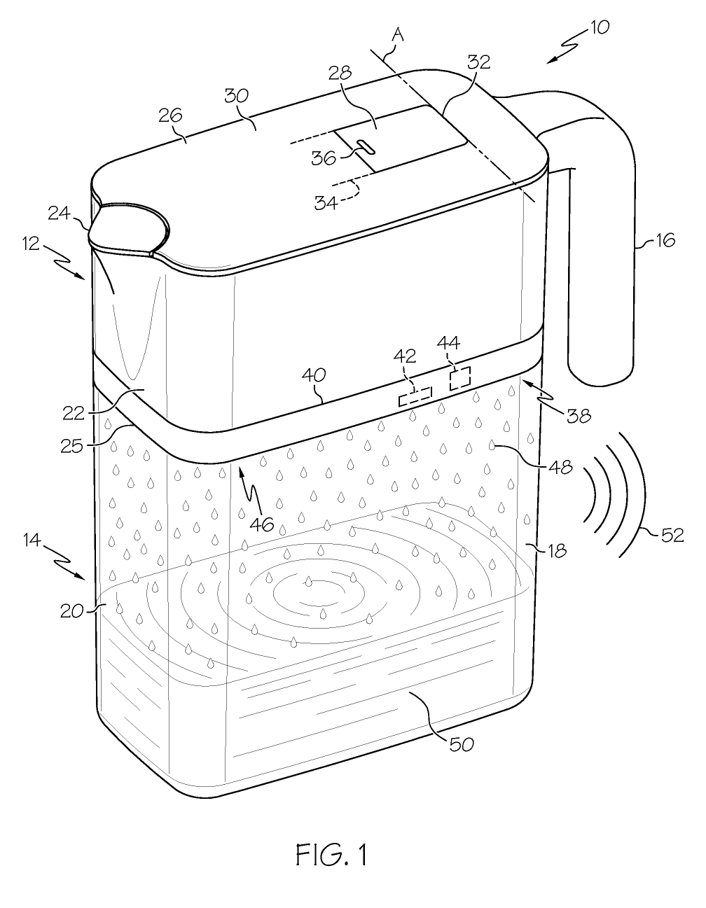

Referring to FIG. 1, an exemplary fluid treatment device 10 is illustrated as a gravity-feed, water filtration carafe including an upper portion 12, a lower portion 14 and a handle 16 located at the upper portion and extending downwardly in a direction toward the lower portion. The lower portion 14 includes a filtered fluid reservoir 18 that is formed by a reservoir housing 20 and the upper portion 12 includes a pouring tray 22 with a pour spout 24 for guiding filtered fluid from the filtered fluid reservoir 18 into, for example, a container, such as a cup or a coffee maker. The pouring tray 22 may be connected to the reservoir housing 20 by any suitable method, such as by a hot-melt sealing process that creates a fluid-tight, sealed seam 25 extending about an entire periphery of the fluid treatment device 10. In an alternate embodiment, the pouring tray 22 may be connected to the reservoir housing 20 by a snap-fit or latched connection along with a seal positioned therebetween to prevent leaking. In another embodiment, the pouring tray 22 may be insertable into the upper portion 12 of the reservoir housing 20 (i.e., no sealed seam 25 is present) and the pouring tray 22 may be completely removable so that the water filtration carafe can be used without the pouring tray 22 once the filtration process is complete.

A lid 26 covers the pouring tray 22 and prevents unintended spillage from the fluid treatment device 10. In some embodiments, the lid 26 is removable from the fluid treatment 10, for example, to access contents of the fluid treatment device. In the illustrated embodiment, the lid 26 includes an openable member 28, such as a door or hatch, located at a top surface 30 of the lid. The openable member 28 opens relative to the lid 26, for example, by pivoting or sliding the openable member relative to the lid. In some embodiments, the openable member 28 is movably connected to the lid, for example, by a hinge 32 and/or any other suitable connection such as a sliding connection represented by dashed lines 34. The hinge 32 allows the openable member 28 to pivot about axis A relative to the lid to position the openable member 28 between open and closed positions. In other embodiments, the openable member 28 is completely removable from the lid 26. The openable member 28 and/or lid 26 may include interlocking structures (e.g., latches, catches, etc.) so that the openable member may releasably interlock with the lid with the openable member in the closed position, which can inhibit unintended opening of the openable member. The openable member 28 may include grasping structure 36 so that a user can manually grasp the openable member 28 and move the openable member 28 relative to the lid 26. In alternative embodiments, the lid 26 may not include the openable member 28 and, to fill the pouring tray 22, the lid is removed or otherwise opened.

An intermediate portion 38 is located between the upper portion 12 and the lower portion 14. In one embodiment, the intermediate portion is part of the pouring tray 22. In an alternative embodiment, the intermediate portion may be part of the reservoir housing 20. In yet another embodiment, the intermediate portion may be a separate component (e.g., a ring of material) that is connected to both the pouring tray 22 and the reservoir housing (e.g., by a hot-melt sealing process, creating a fluid-tight seam 40 and the seam 25). The intermediate portion 38 may provide a visual indication to a user of a separation between the pouring tray 22 and the reservoir housing 20. For example, the intermediate portion 38 may be a first color (e.g., blue), the pouring tray 22 may be a second, different color (e.g., white or grey) and the reservoir housing may be a third, different color, transparent or translucent. In some embodiments, the color scheme of the intermediate portion 38, the upper portion 12 and the lower portion 14 may be selected to provide a scenic representation to a user that is pleasing. For example, the intermediate portion 38 may be blue to represent a sky, the pouring tray 22 may be white or grey to represent clouds and the reservoir housing 20 may be transparent or clear so that contents of the reservoir housing can be viewed from outside the fluid treatment device 10. In some embodiments, only a portion of the reservoir housing 20 may be transparent. For example, the reservoir housing 20 may have visual indicators printed or painted thereon, such as flowers, land, bodies of water, grass, animals, buildings, etc. In some embodiments, only one or more discrete portions of the reservoir housing 20 may be transparent, while the remaining portions are opaque or translucent.

In some embodiments, a light emitting device (represented by element 42), such as an LED or any other suitable light source, may be located at the intermediate portion 38. The light emitting device 42 may be located in a sealed compartment within the pouring tray 22. In one embodiment, the intermediate portion 38 is translucent, permitting light to pass therethrough, for example, to highlight or illuminate regions of the fluid treatment device 10. A power source (represented by element 44), such as a battery (e.g., a disposable or rechargeable battery) may be provided to supply power to the light emitting device 42.

As will be described in greater detail below, a droplet forming fluid filtering system, generally indicated by element 46, is provided between the upper portion 12 and the lower portion 14. The droplet forming fluid filtering system 46 filters fluid placed within the pouring tray 22 (within an upper reservoir) and forms individual droplets 48 of filtered fluid as the fluid passes from the intermediate portion 38 and into the reservoir housing 20. The droplets 48 collect within the filtered fluid reservoir 18 of the reservoir housing 20 forming a pool 50 of filtered water having a water surface that is in contact with an internal perimeter of the reservoir housing 20. As the droplets 48 collect within the reservoir housing 20, sounds 52 of the impact of the falling droplets can be heard from outside the fluid treatment device 10, creating somewhat of a soothing rain-like sound that may be pleasing to a listener. Material forming the fluid treatment device 10 may be selected to provide the rain-like sound. In some instances, the reservoir housing 20 and/or the pouring tray 22 may be acoustically shaped to enhance or amplify the rain-like sound, for example, using any suitable acoustical engineering techniques involving the generation, propagation and reception of mechanical waves and vibrations. In some embodiments, the fluid treatment device may include an amplifying device, such as a microphone and speaker.

The reservoir housing 20 may be formed of any suitable material, such as glass, metal or any suitable plastic material. In some embodiments, the reservoir housing 20 is formed of a transparent or translucent material. The pouring tray 22 and lid 26 may also be formed of any suitable materials, such as glass or any suitable plastic material. In some embodiments, the pouring tray 22 and/or lid 26 may be formed of an opaque or translucent material. The pouring tray 22 and lid 26 may be formed of the same or of different materials.

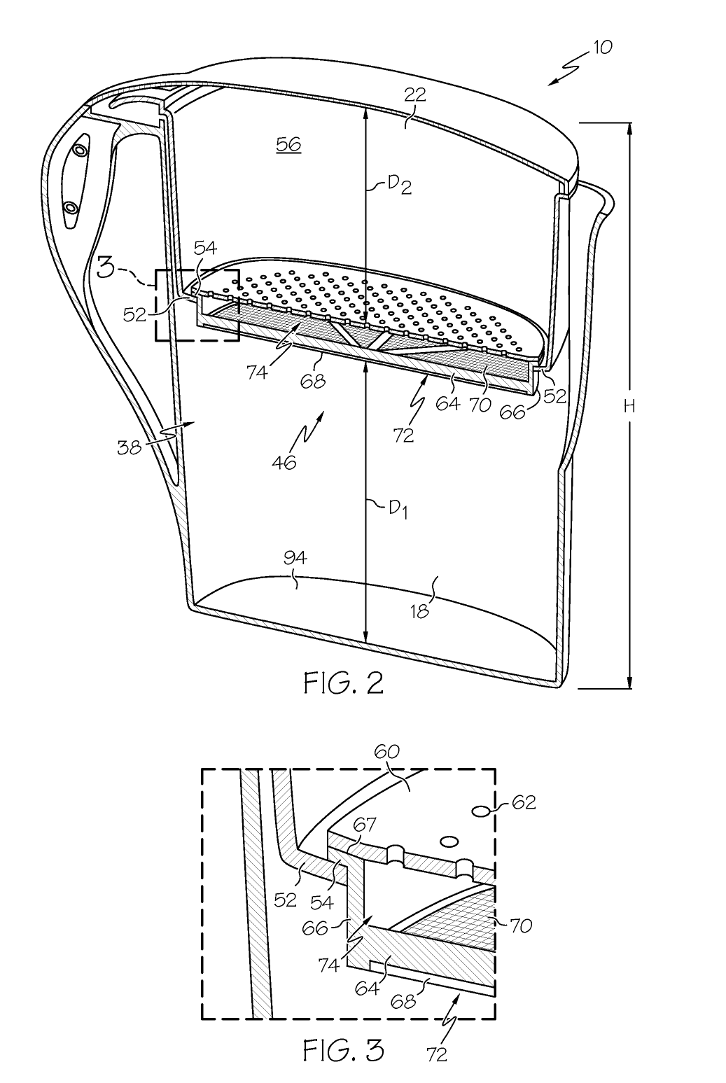

Referring now to FIGS. 2 and 3, the droplet forming fluid filtering system 46 is shown mounted at the intermediate portion 38 of the fluid treatment device 10. The intermediate portion 38 of the pouring tray 22 includes an inwardly facing lip 52 that provides a support surface against which the droplet forming fluid filtering system 46 can rest. In the illustrated example, the inwardly facing lip 52 provides a support on which the droplet forming fluid filtering system 46 hangs in a horizontal fashion. However, other arrangements are contemplated where the droplet forming fluid filtering system 46 (or portions thereof) is oriented at an angle to the horizontal. The droplet forming fluid filtering system 46 includes an outwardly facing lip 54 that may sealingly engage the inwardly facing lip 52, forming a fluid-tight seal therebetween about the periphery of the droplet forming fluid filtering system to inhibit fluid from bypassing the droplet forming fluid filtering system when the upper reservoir 56 is filled with fluid. In some embodiments, other connection structure may be provided between the inwardly facing lip 52 and the outwardly facing lip 54, for example, to enhance the seal, such as a tongue and groove connection, weep holes, etc. thereby providing a tortuous leak path between the upper reservoir 56 and lower reservoir 58. In one embodiment, a sealing member, such as a sealing ring (e.g., formed of rubber or plastic) may be located between the inwardly facing lip 52 and the outwardly facing lip 54. Caulking may be used to seal the interface between the inwardly facing lip 52 and the outwardly facing lip 54.

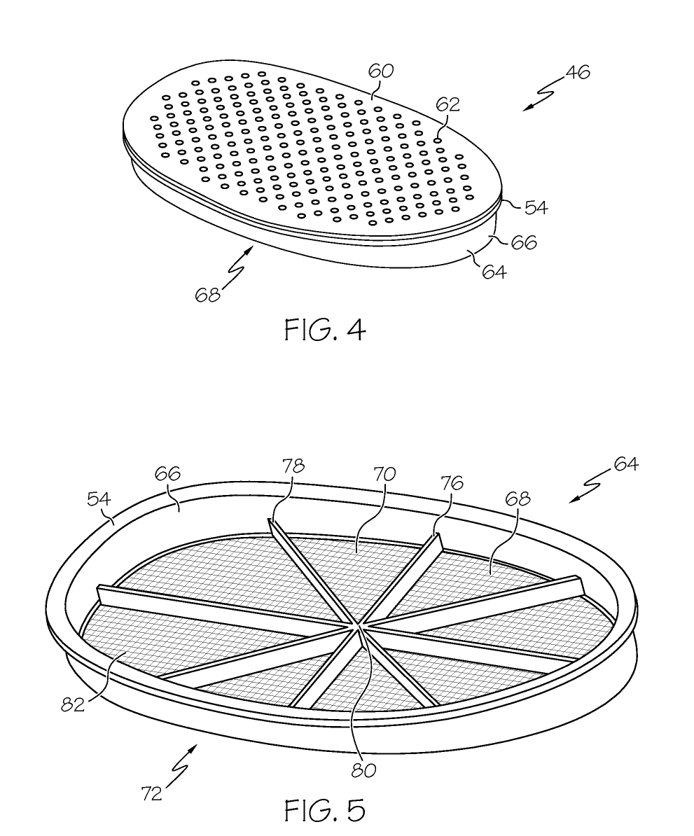

Referring also to FIG. 4, the droplet forming fluid filtering system 46, in the illustrated embodiment, is in the form of a removable cartridge including a cartridge lid 60 with an array of openings 62 extending through the cartridge lid and arranged over its surface area. In some embodiments, the droplet forming fluid filtering system 46 may be made disposable. In one embodiment, the droplet forming fluid filtering system 46 or portions thereof, may be fixedly or removably installed within the fluid treatment device 10. For example, the droplet forming fluid filter system 46 may be connected to the pouring tray 22 (e.g., the intermediate portion 38) using any suitable interlocking or fastener connection, including but not limited to snap-fit, welds (e.g., sonic welds), adhesives, and/or any other known methods of connection. The droplet forming fluid filtering system 46 may be in any suitable shape, for example, to match or correspond to the shape of the pouring tray 22 and/or the reservoir housing 20. Any suitable shapes are possible, including circular, oval, rectangular, etc. The openings 62 are sized and arranged so as not to be a flow restriction and to allow unfiltered fluid to enter the droplet forming fluid filtering system 46 for a filtering operation. The cartridge lid 60 may be formed using any suitable material, such as an injection molded polymer, or other materials such as a woven material, a non-woven polymer material, a mesh material, composite materials, etc.

A rain-effect delivery system 64 is connected to the cartridge lid 60. The rain-effect delivery system 64 may include the outwardly facing lip 54 and a peripheral wall 66 that extends downwardly from the cartridge lid 60. The rain-effect delivery system 64 is connected to the cartridge lid at an interface 67 (FIG. 3). In some embodiments, the rain-effect delivery system 64 may be removably connected to the cartridge lid 60, for example using any suitable interlocking or fastener connection. Alternatively, the rain-effect delivery system 64 and the cartridge lid 60 may be bonded together through any suitable method such as welding, adhesive, etc.

The rain-effect delivery system 64 includes a delivery component 68 that is connected to the peripheral wall 66. The delivery component 68 includes an inner fluid receiving surface 70 and an outer fluid delivery surface 72 opposite the inner fluid delivery surface. The inner fluid receiving surface 70 and the outer fluid delivery surface 72 may be of any suitable contour or shape, such as planar (e.g., in a horizontal plane) or one or both of the inner and outer surfaces may have some curvature. The inner fluid delivery surface 70 is spaced vertically from the cartridge lid 60. As can most be seen clearly by FIGS. 2 and 3, the spacing between the cartridge lid 60 and the rain-effect delivery system 64 provides an enclosure 74 therebetween for holding a filter material (not shown). In some embodiments, vertical spacing between the inner fluid receiving surface 70 and the cartridge lid 60 may be at least about 0.25 inch, at least about 0.5 inch, at least about 0.75 inch or more. In other embodiments, the vertical spacing between the inner fluid receiving surface 70 and the cartridge lid 60 may be less than 0.25 inch. Spacing between the inner fluid receiving surface 70 and the cartridge lid 60 may depend on a number of factors including the type and structure of filter media used.

FIG. 5 illustrates the rain-effect delivery system 64 in isolation. The rain-effect delivery system 64 includes the peripheral wall 66 with the outwardly facing lip 54, delivery component 68 with the inner fluid receiving surface 70 and outer fluid delivery surface 72. Reinforcement members 76 in the form of ribs extend toward each other, along the inner fluid receiving surface 70 and toward a center of the delivery component 68. The reinforcement members 76 each have one end 78 connected to the peripheral wall 66 and an opposite end 80 connected to the other reinforcement members in the center of the rain-effect delivery system 66. Reinforcement members 76 may be any other suitable configuration and help to support the delivery component 68 in the illustrated horizontal arrangement.

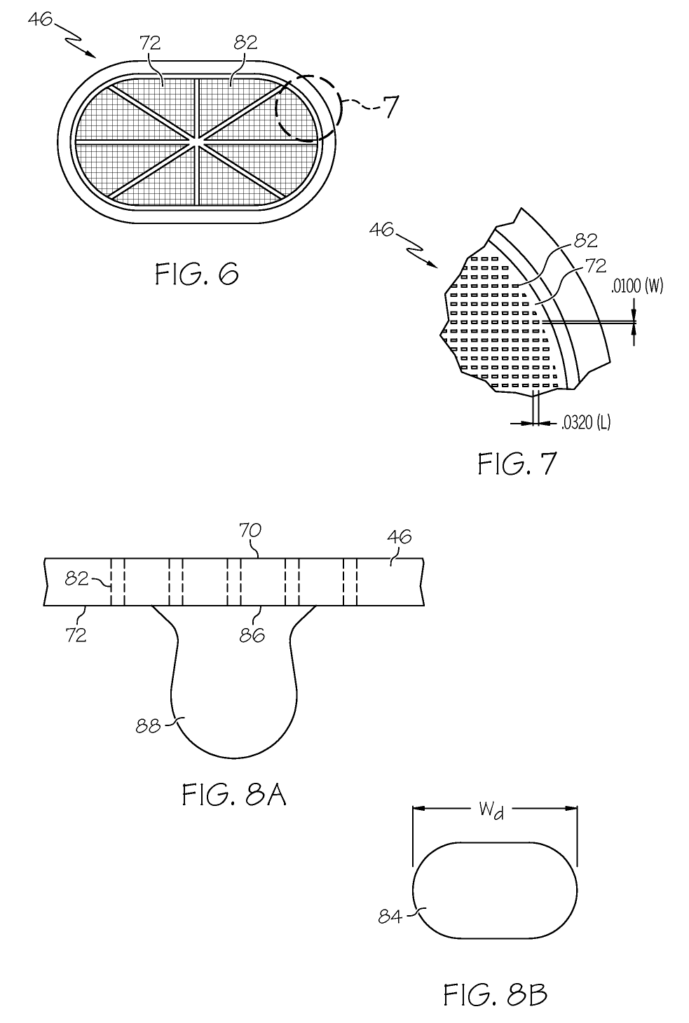

Referring also to FIGS. 6 and 7, openings 82 are spread over the inner fluid receiving surface 70 and the outer fluid delivery surface 72 in both width-wise and length-wise directions. The openings 82 extend all the way through the delivery component 68 forming channels from the inner fluid receiving surface 70 to the outer fluid delivery surface 72. In one exemplary embodiment, the openings may be sized and arranged to provide a free open area from about five percent to about 20 percent of the total surface area of the inner fluid receiving surface 70 (or outer fluid delivery surface 72), such as about 11 percent or more free open area of the inner fluid receiving surface (or outer fluid delivery surface). In some embodiments, there may be less than five percent free open area. In some embodiments, the delivery component 68 having an inner fluid receiving surface 70 (or outer fluid delivery surface 72) with a total surface area of about 15 square inches may have from about 2500 to about 7000 openings 82, such as about 5691 openings. Any other arrangement of openings 82 suitable for forming a rain-effect may be utilized.

Referring particularly to FIG. 7, the openings 82, in one illustrative embodiment, are in the shape of rectangular slots. Any other suitable shape for the openings 82 may be used such as round openings, oval openings, etc. In the embodiment of FIG. 8A, the slots are about 0.01 inch in width W and about 0.032 inch in length L. In other embodiments, slots may have larger or smaller widths and lengths. Additionally, openings 82 may all be of about the same dimensions or openings 82 may be of different dimensions. Adjacent openings 82 may be separated in the width-wise direction by a distance from about 0.02 inch to about 0.06 inch, such as about 0.04 inch and are separated in the length-wise direction by a distance from about 0.015 inch to about 0.06 inch, such as about 0.0245 inch. Any combination of suitable opening separations may be utilized including greater or less separation distances. Additionally, the same or different separation distances may be used between the adjacent openings 82. The openings 82 allow fluid to travel from the inner fluid receiving surface 70 to the outer fluid delivery surface 72, while inhibiting passage of filer media therethrough into the lower reservoir 58. In other words, the rain-effect delivery system 64 serves as a barrier against passage of filter media into the lower reservoir 58.

Two factors that assist in the formation of droplets on the outer fluid delivery surface 72 are surface tension of the fluid and surface energy of the fluid delivery surface 72 of the rain-effect delivery system 64. FIG. 8A diagrammatically illustrates formation of a droplet 84. In FIG. 8A, a droplet 84 may form when liquid accumulates at the surface boundary 86 of the outer fluid delivery surface 72, producing a hanging pendant drop 88. The pendant drop 88 clings (e.g., temporarily) to the outer fluid delivery surface 72 until its size (e.g., mass) overcomes the surface energy. The droplet 84 then falls under gravity until it reaches the bottom of the filtered fluid reservoir 18 or the rising filtered water line. The liquid forms the droplet 84 due to surface tension.

Various materials provide differing surface energies. In one embodiment, a surface energy of less than pure water (i.e., about 72.8 dynes/cm), such as from about 20 dynes/cm to about 70 dynes/cm, such as from about 20 dynes/cm to about 60 dynes/cm, such as about 42 dynes/cm may be used to form the outer fluid delivery surface 72. Surface energy of a material may be determined by any suitable technique, such as using dyne solutions, measuring contact angle of a drop having a known surface tension, etc. Materials having higher surface energies, e.g., approaching the surface tension of water can be utilized to create larger droplet sizes. By contrast, materials having lower surface energies can be utilized to create smaller droplet sizes. In some embodiments, referring to FIG. 8B, droplets 84 may have a width W_{d} from about two mm to about seven mm, such as about 5.5 mm per droplet and a volume from about 0.05 mL to about 0.25 mL, such as about 0.1 mL to about 0.2 mL, such as about 0.150 mL per droplet. The width W_{d} is determined by the maximum side-to-side measurement of a falling droplet 84. Suitable materials for forming the outer fluid delivery surface may include, for example, polymer materials such as fluoropolymers and polycarbonates, ceramic materials, etc. Additionally, altering the outer fluid delivery surface 72 such as by machining, coating, etc. can be used to increase or decrease the surface energy of the material. In some embodiments, the outer fluid delivery surface 72 may be formed by a coating, a film, etc. formed of a higher (or lower) surface energy material.

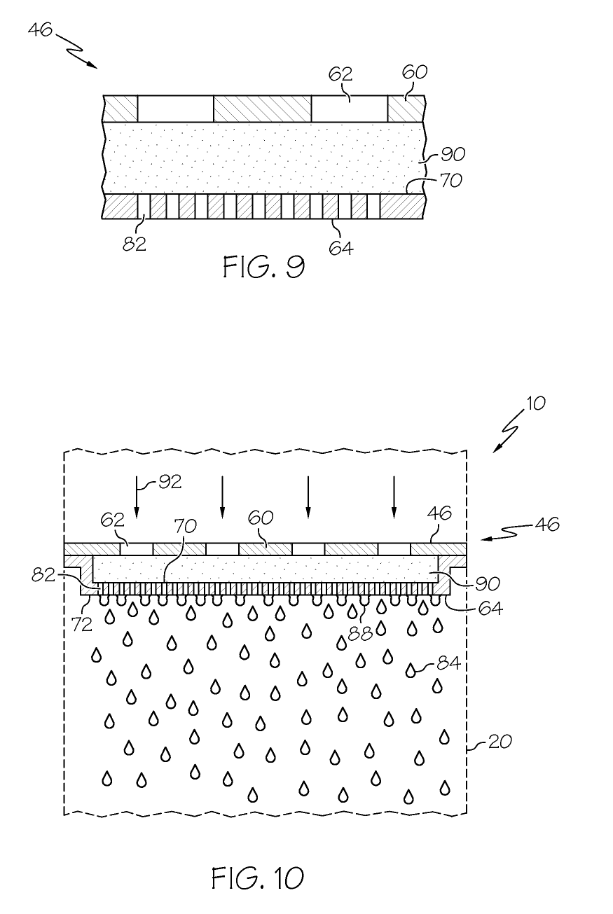

Referring now to FIG. 9, the filter media 90 is located between the cartridge lid 60 and the rain-effect delivery system 64. The filter media 90 filters the fluid, helps to regulate fluid flow to the rain-effect delivery system 64 and to distribute the fluid over the entire inner fluid receiving surface 70.

It has been discovered that many consumers may prefer to keep their filtered water stored in the lower reservoir 58 separate from the filter cartridge, to the extent possible. To this end, the fluid treatment device 10, in some embodiments, is provided with the droplet forming fluid filtering system 46 in a flat, horizontal configuration (i.e., a flat cartridge). Thus, the filter media 90 may be suitable for a flat cartridge configuration, while providing the desired filtering and flow rate.

Fluid contaminants, particularly contaminants in water, may include various elements and compositions such as heavy metals (e.g., lead), microorganisms (e.g., bacteria, viruses), acids (e.g., humic acids), or any contaminants listed in NSF/ANSI Standard No. 53. As used herein, the terms “microorganism”, “microbiological organisms”, “microbial agent”, and “pathogen” are used interchangeably. These terms, as used herein, refer to various types of microorganisms that can be characterized as bacteria, viruses, parasites, protozoa, and germs. In a variety of circumstances, these contaminants, as set forth above, should be removed or reduced to acceptable levels before the water can be used. Harmful contaminants should be removed from the water or reduced to acceptable levels before it is potable, i.e., fit to consume.

In some embodiments, the droplet forming fluid filtering system 46 may include an activated carbon filter, a fiber composite filter, a fluid filter comprising an activated carbon filter and a fiber composite filter, an activated carbon filter coated or blended with metals, polymers, oxides, or binders (e.g., silver, cationic polymers, amorphous titanium silicate, etc.) or combinations thereof to remove contaminants from a fluid. Exemplary filters that may be used in the droplet forming fluid filtering system 46 may include filters and filter systems shown and described in U.S. Pat. Nos. 6,139,739, 6,290,848, 6,395,190, 6,630,016, 6,852,224, 7,316,323, U.S. Publication Nos. 2001/0032822, 2003/0217963, 2004/0164018, 2006/0260997, 2007/0080103 and 2008/0116146, U.S. Provisional Patent Ser. No. 61/079,323 and EP1694905 which are all herein incorporated by reference in their entirety.

The filter may be molded into a flat configuration, pleated, or formed into any other suitable structure for forming the droplet forming fluid filtering system 46. An exemplary fiber composite filter may comprise an alumina based composite filter (“alumina based filter”). The activated carbon filters or fiber composite filters may be pressed or molded into a suitable flat shape (e.g., a flat-shape block) and are operable to remove contaminants such as heavy metals, humic acids, and/or microorganisms from fluids, or may be used in tandem to remove such contaminants more effectively and/or at an increased level. The fluid path through the filter may be varied from vertical (e.g., have some partially horizontal path) to achieve sufficient filtration. The fluid filters may be used in industrial and commercial applications as well as personal consumer applications, e.g., household and personal use applications. The fluid filter is operable to be used with various fixtures, appliances, or components.

It is contemplated that the fluid filter may comprise various fiber composite filters that comprise fibers that are highly electropositive and may be distributed on fibers such as a glass fiber scaffolding. In one exemplary embodiment, the fluid filter may comprise an activated carbon filter combined with an alumina based filter to remove contaminants from fluids (e.g., water) such as heavy metals (e.g., lead), microorganisms (e.g., bacteria and viruses), and/or other contaminants from fluids (e.g., water). Specifically, the activated carbon filter may comprise various suitable compositions and structures.

An exemplary embodiment of a fluid filter may be operable to produce potable water by passing untreated water from a water source through both the activated carbon and the alumina based filters. The alumina based filter may be a separate and distinct filter from the activated carbon filter or the alumina based and activated carbon filters may be fabricated as a single, integral unit. In one exemplary embodiment, the activated carbon filter particles may be imbedded into the alumina based filter.

In another exemplary embodiment, the fluid filter may comprise an activated carbon filter and an alumina based filter that is positioned in series with and upstream from the activated carbon filter, wherein the fluid filter is operable to remove contaminants (e.g., heavy metals, microorganisms, and other contaminants) from fluids (e.g., water) to produce treated fluids (e.g., potable water). As such, the activated carbon filter may include various suitable compositions and structures operable to remove heavy metals, microorganisms, and/or other contaminants.

Referring to FIG. 10, the droplet forming fluid filtering system 46 is shown in operation, forming individual droplets 84 of filtered water that fill the reservoir housing 20. As represented by the arrows 92, unfiltered water (e.g., from a tap) flows through the openings 62 in the cartridge lid 60. The filter media 90 distributes the water and filters the water to remove contaminants from the water. The filtered water then moves to the rain-effect delivery system 64 and passes through the openings 82 from the fluid receiving surface 70 to the fluid delivery surface 72. Due to surface energy, the filtered water clings to the fluid delivery surface 72, forming a pendant drop 88 at drop points on the fluid delivery surface 72. As can be seen, multiple pendant drops 88 are formed simultaneously and at somewhat random locations over the fluid delivery surface 72. A droplet 84 detaches itself from the pendant drop 88 once the size (e.g., mass) of the droplet overcomes the attraction to the fluid delivery surface 72. In some embodiments, the filter media 90 provides a flow rate from about 85 mL per minute to about 500 mL per minute or higher, such as about 580 mL/min. In some embodiments, the flow rate through the filter media may be about 250 mL per minute. In some embodiments, an effective droplet rate of filtered water is from about nine drops per second to about 200, such as about 56 drops per second, such as about 167 drops per second. As one example of a particular embodiment, from about 2000 to about 100000 droplets of filtered water may be formed per liter of unfiltered water, such as about 4000 to about 25000, such as about 4000 to about 12000, such as about 7000 droplets per liter. For a water treatment device 10 having a capacity of about 1.7 liters, in one embodiment, the duration for which a rain-effect is produced may be from about 3.4 minutes to about 20 minutes.

It should be noted that flow rates and drops per second may change with changes in pressure in the upper reservoir. Thus, flow rates and drops per second may refer to an instantaneous flow rate and/or drops per second value and/or an average flow rate and/or drops per second value.

Initially, the water droplets 84 impact a bottom 94 (FIG. 2) of the reservoir housing 20 providing a first rain-effect sound of droplets hitting a solid surface. As the filtered water level rises in the reservoir housing 20, a second rain-effect sound of droplets hitting a pool of water is produced that may be different from the first rain-effect sound. Kinetic energy from the falling droplets 84 is transferred to the pool of water. The droplets 84 may bounce as they strike the surfaces of the reservoir housing 20 and the pool of water. In some instances, multiple droplets may be formed when a droplet 84 collides with one or more of the surfaces. As the droplets 84 strike the pool of water, the water surface may be disrupted and create waves. Water droplets may be ejected from the pool of water due to droplet collision with the water surface. Interference patterns may form on the water surface from the multiple waves formed by falling droplets impacting the water surface.

As noted above, it may be desirable to locate the droplet forming fluid filtering system 46 above the lower reservoir 58 and away from the filtered water. In some embodiments, referring briefly to FIG. 2, a vertical distance D₁ from the fluid delivery surface 72 to a bottom 94 of the reservoir housing 20 is at least about 20 percent or more, such as about 30 percent of more, such as about 50 percent or more of a total height H of the water treatment device. In some embodiments, D₁ may be from about five cm to about 100 cm, such as from about five cm to about 50 cm. In some embodiments, a vertical distance D₂ from the lid 26 to the cartridge lid 60 is at most about 50 percent or less, such as at most about 20 percent or less of a total height H of the water treatment device. In some embodiments, the rain-effect may be produced for about 20 percent or more by volume or time of the interval that the reservoir housing 20 is filling due, at least in part, to D₁ and geometry of the droplet forming filtering system 46 and reservoir housing 20.

The area of droplet formation on the droplet forming fluid filtering system 46 can be varied depending on the shape of the droplet forming fluid filtering system including the shape of the rain-effect delivery system 64 including where the openings 82 are placed. While the fluid delivery surface 72 is illustrated as substantially flat, it may be any other suitable shape, such as an inverted frustoconical shape so as to direct droplets forming at a periphery of the rain-effect delivery system 46 toward its center and away from the reservoir housing 20. As can be appreciated from many of the above FIGS., a ratio of the filter footprint (i.e., area) to the bottom of the reservoir housing is relatively large, e.g., at least about 50 percent of the area of the bottom, such as at least about 75 percent of the area of the bottom, such as about 100 percent of the area of the bottom or more. This relatively high filter footprint to bottom area ratio can help to distribute the filtered water and create a rain-effect over a larger volume of the lower reservoir 58.

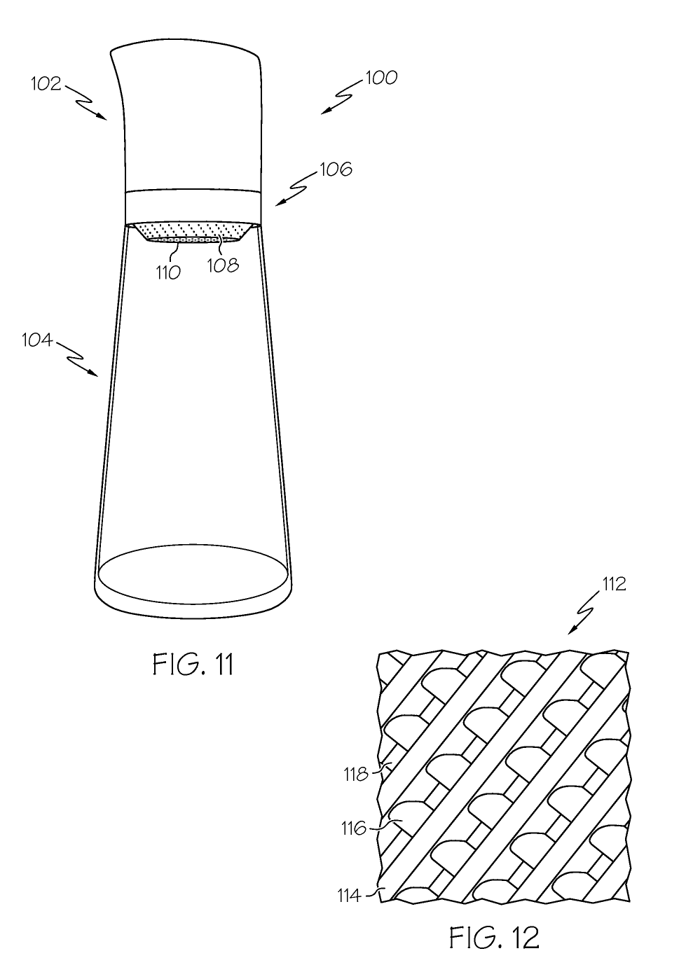

Referring to FIG. 11, another exemplary fluid treatment device 100 in the form of a gravity-feed, water filtration carafe includes many of the above described features including an upper portion 102, a lower portion 104 and an intermediate portion 106. A droplet forming fluid filtering system 108 is located at the intermediate portion 106 that includes a rain-effect delivery system 110, a cartridge lid (not shown) and a filter media (not shown) for filtering fluid and providing individual droplets of filtered fluid in a fashion similar to that described above with reference to fluid treatment device 10. The fluid treatment device 100 is sized to be grasped and, for example, placed on a dining table for a source of filtered water at the dining table.

Having described various embodiments, it will be apparent that modifications and variations are possible without departing from the scope of the invention defined in the appended claims. For example, the rain-effect delivery systems 64 and 110 may be formed by any suitable method, such as by molding, pressing, machining, etc. The openings 82 may be formed during a molding process, by machining, etc. FIG. 12 shows an embodiment of a rain-effect delivery system 112 having a somewhat mesh-like or grid-like structure with transverse members 114 and 116 forming openings 118 that pass between fluid receiving and fluid delivery surfaces. In some embodiments, the rain-effect delivery system may be formed using woven or non-woven materials.

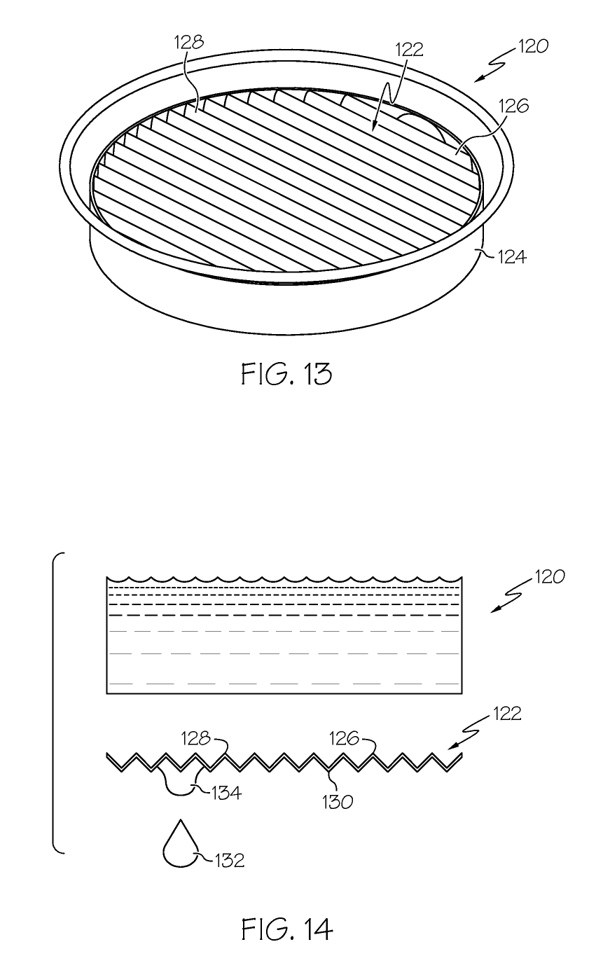

For example, referring now to FIGS. 13 and 14, another exemplary rain-effect delivery system 120 generally includes a delivery component 122 that is connected to a peripheral wall 124. The delivery component 122, in this embodiment, is formed, for example, by a non-woven filter material having a series of pleats 126 or folds that extend across the width of the delivery component 122 between opposite sides of the peripheral wall 124. The delivery component 122 includes an inner fluid receiving surface 128 that is opposite an outer fluid delivery surface 130. The inner fluid receiving surface 128 and the outer fluid delivery surface 130 have a somewhat undulating or wavy surface pattern formed by the pleats 126.

Referring particularly to FIG. 14, the outer fluid delivery surface 130 has a surface energy to assist in the formation of droplets of water on the outer fluid delivery surface 130. The contribution of the surface energy in water droplet formation may be affected by the shape of the undulating surface pattern and pleats 126. FIG. 14 diagrammatically illustrates formation of a droplet 132. A droplet 132 may form when liquid accumulates at the surface boundary of the outer fluid delivery surface 130, producing a hanging pendant drop 134. The pendant drop 134 clings (e.g., temporarily) to the outer fluid delivery surface 130 until its size (e.g., mass) overcomes the surface energy. The droplet 132 then falls under gravity until it reaches the bottom of the filtered fluid reservoir or the rising filtered water line, as described above. It should be noted that in embodiments where a filter material is used to form the delivery component 122, the delivery component itself may be used to at least partially filter the water while providing the outer fluid delivery surface 130. In some instances, other filter materials, such as one or more of those discussed above, may be used along with the delivery component 122 to filter the water. For example, other filter materials may be located above the delivery component 122 through with the water travels before reaching the inner fluid receiving surface 128 of the delivery component 122.

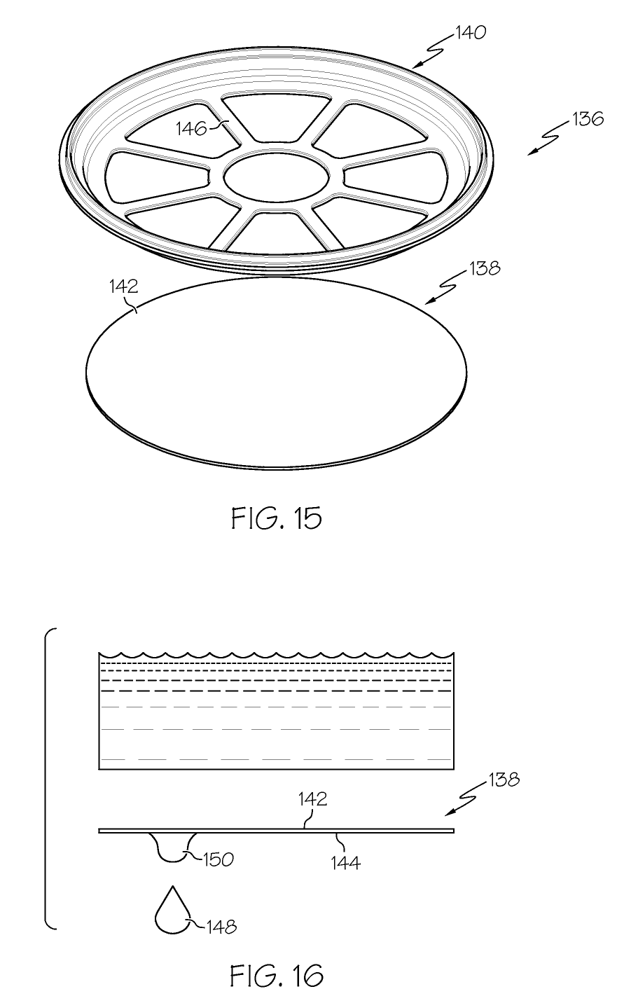

Referring to FIGS. 15 and 16, another exemplary rain-effect delivery system 136 generally includes a delivery component 138 that is connected to a lower filter cartridge support 140. The delivery component 138, in this embodiment, is formed, for example, by a non-woven filter material that is relatively planar in shape. The delivery component 138 includes an inner fluid receiving surface 142 that is opposite an outer fluid delivery surface 144. In some embodiments, the delivery component 138 may be seated within (e.g., on top of) the lower filter cartridge support 140 such that the outer fluid delivery surface 144 is supported by spokes 146 of the lower filter cartridge support 140. As an alternative, the delivery component 138 may be located beneath the lower filter cartridge support 140, e.g., by adhering the inner fluid receiving surface to the spokes 146, for example, by adhesive, thermal bonding, etc.

Referring particularly to FIG. 16, the outer fluid delivery surface 144 has a surface energy to assist in the formation of droplets of water on the outer fluid delivery surface 144. FIG. 16 diagrammatically illustrates formation of a droplet 148. A droplet 148 may form when liquid accumulates at the surface boundary of the outer fluid delivery surface 144 (where exposed between adjacent spokes 146), producing a hanging pendant drop 150. The pendant drop 150 clings (e.g., temporarily) to the outer fluid delivery surface 144 until its size (e.g., mass) overcomes the surface energy. The droplet 148 then falls under gravity until it reaches the bottom of the filtered fluid reservoir 18 or the rising filtered water line, as described above.

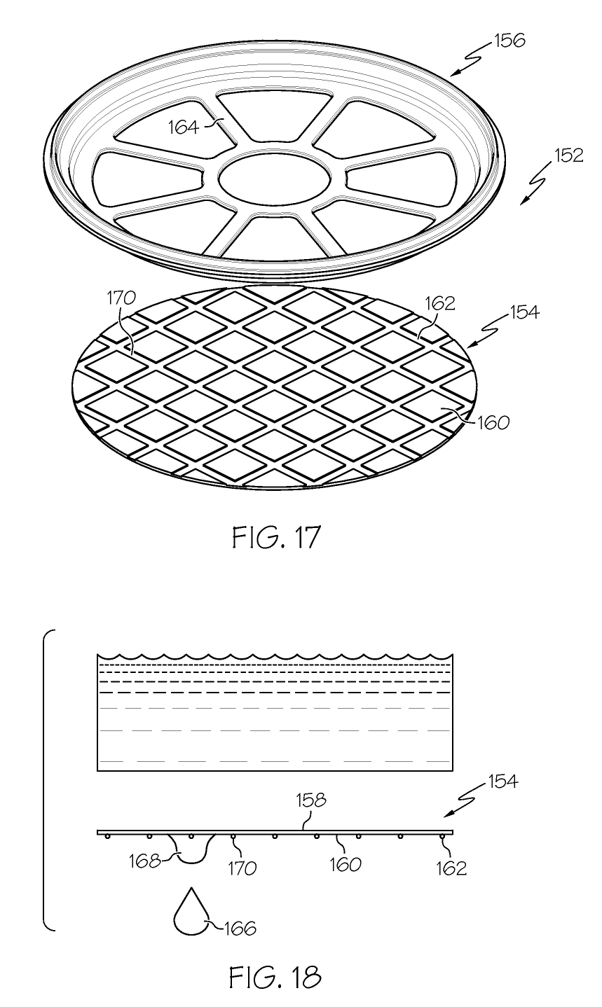

Referring to FIGS. 17 and 18, another exemplary rain-effect delivery system 152 generally includes a delivery component 154 that is connected to a lower filter cartridge support 156. The delivery component 154, in this embodiment, is formed, for example, by a non-woven filter material that is relatively planar in shape. The delivery component 154 includes an inner fluid receiving surface 158 that is opposite an outer fluid delivery surface 160. A screen or mesh component 162 is provided at the outer fluid delivery surface 160. In some embodiments, the delivery component 154 (including mesh component 162) may be seated within (e.g., on top of) the lower filter cartridge support 156 such that the outer fluid delivery surface 160 is supported by spokes 164 of the lower filter cartridge support 156. As an alternative, the delivery component 154 may be located beneath the lower filter cartridge support 156, e.g., by adhering the inner fluid receiving surface 158 to the spokes 164.

Referring particularly to FIG. 18, the outer fluid delivery surface 160 has a surface energy to assist in the formation of droplets of water on the outer fluid delivery surface 160. FIG. 18 diagrammatically illustrates formation of a droplet 166. A droplet 166 may form when liquid accumulates at the surface boundary of the outer fluid delivery surface 160, producing a hanging pendant drop 168. The pendant drop 168 clings (e.g., temporarily) to the outer fluid delivery surface 160 until its size (e.g., mass) overcomes the surface energy. In some embodiments, members 170 of the mesh component 162 become a collection site that helps in collecting the pendant drops 168 to somewhat control where at least some pendant drops 168 form. The droplet 166 then falls under gravity until it reaches the bottom of the filtered fluid reservoir 18 or the rising filtered water line, as described above.

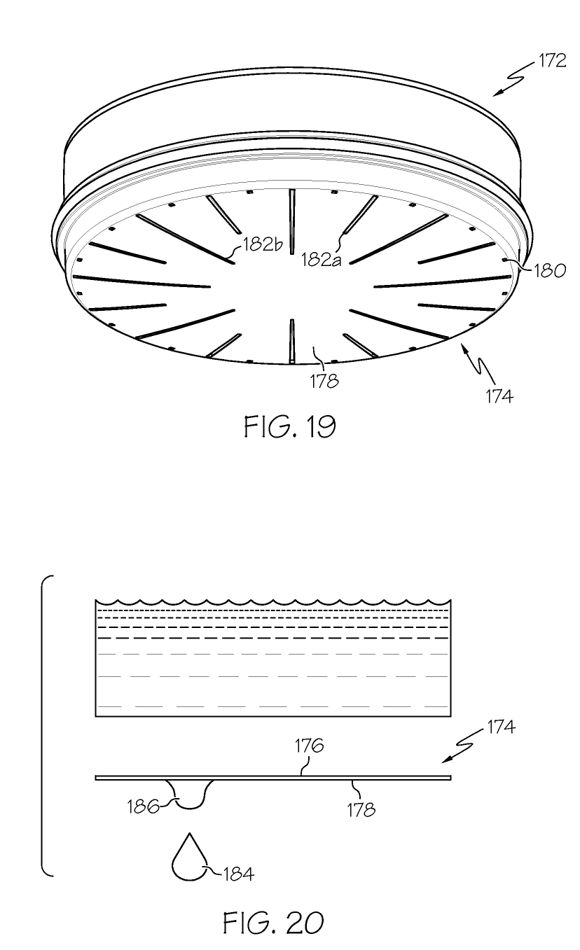

Referring to FIGS. 19 and 20, a rain-effect delivery system 172 generally includes a delivery component 174 (in this instance, formed of plastic or any other suitable material) that can be connected to a pour tray by any suitable fashion. The delivery component 174 includes an inner fluid receiving surface 176 and an outer fluid delivery surface 178 opposite the inner fluid receiving surface 176. The inner fluid receiving surface 176 and the outer fluid delivery surface 178 may be of any suitable contour or shape, such as planar (e.g., in a horizontal plane) or one or both of the inner and outer surfaces may have some curvature.

As can be seen best by FIG. 19, the delivery component 174 includes a number of peripheral openings 180 located about an outer periphery of the delivery component 174 and inwardly extending slots 182a and 182b that extend from the periphery inwardly (e.g., in a radial direction) toward the center of the delivery component 174. The peripheral openings 180 are illustrated as having the shortest length, slots 182a are illustrated as being longer than the peripheral openings 180 and slots 182b are illustrated as having a length greater than that of the slots 182a and openings 180. In other embodiments, the openings 180 may be positioned at other, non-peripheral locations.

Referring particularly to FIG. 20, the outer fluid delivery surface 178 has a surface energy to assist in the formation of droplets of water on the outer fluid delivery surface 178 as water passes through the openings 180 and slots 182. FIG. 20 diagrammatically illustrates formation of a droplet 184. A droplet 184 may form when liquid accumulates at the surface boundary of the outer fluid delivery surface 178, producing a hanging pendant drop 186. The pendant drop 186 clings (e.g., temporarily) to the outer fluid delivery surface 178 until its size (e.g., mass) overcomes the surface energy. The droplet 184 then falls under gravity until it reaches the bottom of the filtered fluid reservoir 18 or the rising filtered water line, as described above.

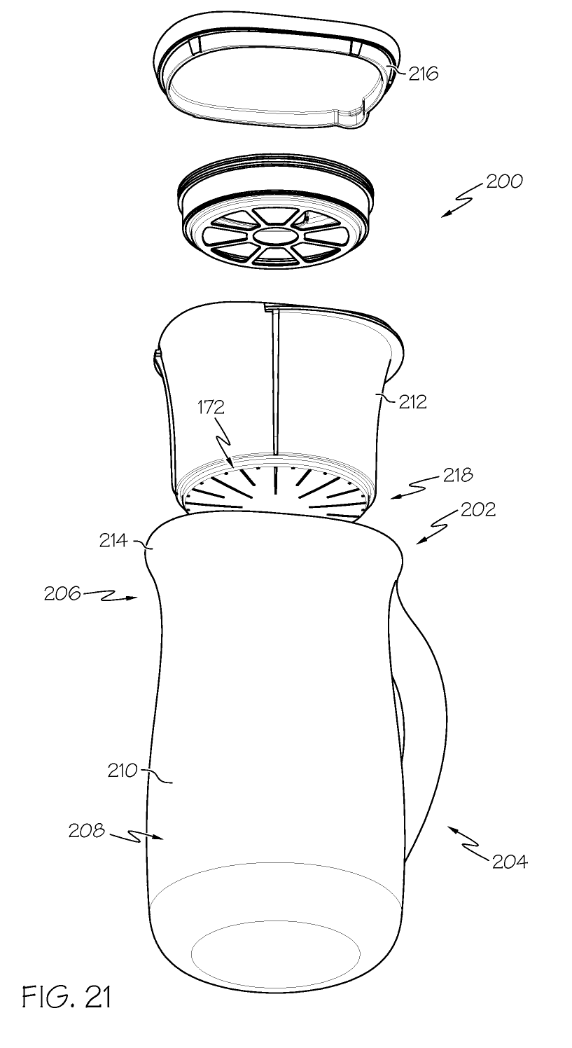

Referring to FIG. 21, another exemplary fluid treatment device 200 is illustrated as a gravity-feed, water filtration carafe including an upper portion 202, a lower portion 204 and an intermediate portion 206. The lower portion 204 includes a filtered fluid reservoir 208 that is formed by a reservoir housing 210 and the upper portion 202 includes a pouring tray 212. A pour spout 214 may be provided for guiding filtered fluid from the filtered fluid reservoir 208. A lid 216 may be used to cover the pouring tray 212 and prevent unintended spillage from the fluid treatment device 200.

The intermediate portion 206 is located between the upper portion 202 and the lower portion 204. A droplet forming fluid filtering system, generally indicated by element 218, is provided at the intermediate portion 206 and includes the rain-effect delivery system 172 of FIG. 19. The droplet forming fluid filtering system 218 filters fluid placed within the pouring tray 212 and forms individual droplets of filtered fluid as the fluid passes from the pouring tray and into the reservoir housing 210 in a fashion similar to that described above.

It is noted that terms like “preferably,” “generally,” “commonly,” and “typically” are not utilized herein to limit the scope of the claimed embodiments or to imply that certain features are critical, essential, or even important to the structures or functions. Rather, these terms are merely intended to highlight alternative or additional features that may or may not be utilized in a particular embodiment.

For the purposes of describing and defining the various embodiments it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

All documents cited in the Detailed Description are, in relevant part, incorporated herein by reference; the citation of any document is not to be construed as an admission that it is prior art. To the extent that any meaning or definition of a term in this written document conflicts with any meaning or definition of the term in a document incorporated by reference, the meaning or definition assigned to the term in this written document shall govern.

While particular embodiments have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fluid treatment device, comprising:
a housing having an upper portion including an upper reservoir for receiving unfiltered fluid, a lower portion including a lower reservoir for receiving filtered fluid and an intermediate portion including a droplet forming fluid filtering system; wherein the droplet forming filtering system comprises a rain-effect delivery system that receives fluid from the upper reservoir, the rain-effect delivery system having a fluid delivery surface configured for forming individual fluid droplets over an area of the fluid delivery surface.

2. The fluid treatment device of claim 1, wherein the fluid delivery surface forms individual fluid droplets defining at least six different drop points over the area of the fluid delivery surface where the droplets fall from the fluid delivery surface.

3. The fluid treatment device of claim 1 further comprising a filter media configured to filter the unfiltered fluid from the upper reservoir.

4. The fluid treatment device of claim 3, wherein the rain-effect delivery system has a fluid receiving surface that receives filtered water from the filter media and the fluid delivery surface opposite the fluid receiving surface, the rain-effect delivery system including passageways extending from the fluid receiving surface to the fluid delivery surface through which filtered fluid travels from the fluid receiving surface to the fluid delivery surface.

5. The fluid treatment device of claim 1, wherein the fluid delivery surface has a surface energy selected for forming individual fluid droplets over an area of the fluid delivery surface.

6. The fluid treatment device of claim 1, wherein the rain-effect delivery system is configured to provide droplets at a rate of about nine droplets per second or more.

7. The fluid treatment device of claim 1, wherein the rain-effect delivery system is configured to provide droplets at a rate of between about nine droplets per second and about 200 droplets per second.

8. The fluid treatment device of claim 1, wherein a surface energy of the fluid delivery surface is from about 20 dynes/cm to about 70 dynes/cm.

9. The fluid treatment device of claim 1, wherein a surface energy of the fluid delivery surface is less than surface tension of the fluid contacting the fluid delivery surface during a filtering operation.

10. The fluid treatment device of claim 1, wherein a surface energy of the fluid delivery surface is selected to form pendant drops of the fluid that cling to the fluid delivery surface during a filtering operation.

11. The fluid treatment device of claim 1, wherein the droplet forming fluid filtering system is in the form of a cartridge.

12. The fluid treatment device of claim 1, wherein the fluid delivery surface is spaced from a bottom of the housing a distance of at least about 30 percent of a total height of the housing.

13. The fluid treatment device of claim 1, wherein the rain-effect delivery system is configured to provide between about 2000 and 25000 droplets of fluid per liter of fluid.

14. The fluid treatment device of claim 1, wherein the droplet forming fluid filtering system is configured to provide a flow rate through the droplet forming fluid filtering system of between about 85 mL/min and about 600 mL/min.

15. A method of providing filtered fluid using a fluid treatment device, the method comprising:
filling an upper reservoir of the fluid treatment device with unfiltered fluid;
filtering the unfiltered fluid thereby providing filtered fluid using a filter media; and
forming individual filtered fluid droplets using a rain-effect delivery system that receives filtered fluid from the filter media, the rain-effect delivery system having a fluid delivery surface configured for forming individual filtered fluid droplets over an area of the fluid delivery surface.

16. The method of claim 15, wherein the fluid delivery surface has a surface energy selected for forming individual filtered fluid droplets over an area of the fluid delivery surface.

17. The method of claim 15, wherein the step of forming the individual filtered fluid droplets includes providing droplets at a rate of about nine droplets per second or more.

18. The method of claim 15, wherein the step of forming the individual filtered fluid droplets includes providing droplets at a rate of between about nine droplets per second and about 56 droplets per second.

19. The method of claim 15, wherein the rain-effect delivery system has a fluid receiving surface facing the filter media and the fluid delivery surface opposite the fluid receiving surface, the rain-effect delivery system including openings extending from the fluid receiving surface to the fluid delivery surface through which filtered fluid travels from the fluid receiving surface to the fluid delivery surface.

20. The method of claim 15, wherein a surface energy of the fluid delivery surface is from about 20 dynes/cm to about 70 dynes/cm.

21. The method of claim 15, wherein a surface energy of the fluid delivery surface is less than surface tension of the filtered fluid contacting the fluid delivery surface.

22. The method of claim 15, wherein the step of forming the individual filtered fluid droplets includes forming pendant drops of the filtered fluid that cling to the fluid delivery surface during filtering.

23. The method of claim 15, wherein the step of forming the individual filtered fluid droplets includes providing between about 2000 and 25000 droplets of fluid per liter of fluid.

24. The method of claim 15, wherein the filter media is configured to provide a flow rate through the filter media of between about 85 mL/min and about 600 mL/min.

25. A fluid treatment device, comprising:
a housing having an upper portion including an upper reservoir for receiving unfiltered fluid, a lower portion including a lower reservoir for receiving filtered fluid and an intermediate portion including a droplet forming fluid filtering system; wherein the droplet forming filtering system comprises:
a filter media configured to filter the unfiltered fluid from the upper portion of the housing; and
a rain-effect delivery system that receives filtered fluid from the filter media, the rain-effect delivery system having a fluid delivery surface having a surface energy selected for forming individual filtered fluid droplets over an area of the fluid delivery surface.

26. The fluid treatment device of claim 25, wherein the fluid delivery surface forms individual filtered fluid droplets defining at least six different drop points over the area of the fluid delivery surface where the droplets fall.
